(19) United States
(12) Patent Application Publication
(10) Pub. No.: US 2025/0392692 A1
(43) Pub. Date: Dec. 25, 2025

(54) HEAD-MOUNTED DISPLAY, USE OF A HEAD-MOUNTED DISPLAY, METHOD AND DEVICE FOR TESTING THE FUNCTION OF A SYSTEM, AND METHOD AND DEVICE FOR VISUALLY DISPLAYING 3D DATA

(71) Applicant: SKAN AG, Allschwil (CH)

(72) Inventors: Björn Glienke, Basel Stadt (CH); Dennis Fabio KIPPER, Basel (CH); Corinna Erika BRAUN, Liestal (CH)

(73) Assignee: SKAN AG, Allschwil (CH)

(21) Appl. No.: 19/311,104

(22) Filed: Aug. 27, 2025

Related U.S. Application Data
(63) Continuation of application No. 19/159,679, filed on Jan. 1, 0001.

(30) Foreign Application Priority Data
Feb. 28, 2023 (DE) 102023104859.7

(51) Int. Cl. H04N 13/344; G09B 23/28; H04N 13/243; H04N 13/275; H04N 13/366

(52) U.S. Cl. CPC H04N 13/344; G09B 23/28; H04N 13/243; H04N 13/275; H04N 13/366

(57) ABSTRACT

A method is provided in which at least one marker (10, 17) is configured or added on the outside in order to permit capture of a pose of a head-mounted device (16).

### CROSS-REFERENCE TO RELATED APPLICATIONS

This application is a continuation of U.S. application Ser. No. 19/159,679, filed Aug. 26, 2025, which is a 371 National Phase of International Patent Application No. PCT/EP2024/055070, filed Feb. 28, 2024, which claims priority from German Patent Application No. 10 2023 104 859.7, filed Feb. 28, 2023, all of which are incorporated herein by reference as if fully set forth.

### TECHNICAL FIELD

The invention further relates to a head-mounted display and the use thereof.

The invention further relates to a method for testing the function of an installation.

The invention further relates to a device for testing the function of an installation.

The invention further relates to a method for visually displaying 3D data and to a corresponding device.

### BACKGROUND

Head-mounted displays are known from practice as VR (virtual reality), AR (augmented reality) and MR (mixed reality) glasses, for example, which are used to display virtual, spatially assigned data, alone or in combination with real scenes, so as to be able to be seen by an onlooker for a wide variety of purposes, often in the entertainment industry, in order to create a spatial impression.

Head-mounted displays are described in the German-language edition of Wikipedia, for example. Accordingly, a head-mounted display can be characterized, for example, as a head-worn visual output device. Such a device may, for example, be designed to present images either on a screen close to the eyes or by means of projection onto the retina in order to complement (AR, MR) or replace (VR) a natural visual impression for an onlooker with an artificially created impression.

It is known practice to perform function tests, in particular on pharmaceutical installations, on cardboard and/or wood models before the often complex production is tackled.

Cardboard and/or wood models for the aforementioned method are known in practice.

It is known practice to use such methods and devices in the entertainment industry sector, in particular with the already mentioned head-mounted displays, in order to present three-dimensional data in an immediately tangible way.

### SUMMARY

The invention is based on the object of extending the opportunities for application of head-mounted displays.

The stated object is achieved, according to the invention, by providing one or more of the features disclosed herein.

Thus, in particular a head-mounted display, in particular VR, AR and/or XR glasses, having means for extrinsically ascertaining a capture pose and having means for intrinsically ascertaining a capture pose is proposed. It is advantageous that the advantages of an intrinsic ascertainment of a capture pose can be combined with the advantages of an extrinsic ascertainment of a capture pose.

Alternatively or additionally, the object is achieved by additional means of the features disclosed herein directed to a head-mounted display. Thus, the invention uses a head-mounted display, for example VR, AR and/or XR glasses, having at least one marker, in particular having more than two markers, for preferably extrinsically ascertaining a capture pose. Three markers are often sufficient to clearly determine a position and an attitude of a real model. However, it is advantageous to add more than three markers, in particular for more complex real models.

Adding markers allows separate detection of a capture pose and alignment even with respect to objects that are outside of the field of view.

It is thus possible for a field of view of the head-mounted display to be easily embedded in a virtual space of the virtual 3D model by way of a 3D measurement. This gives an onlooker a realistic impression of an installation or of complex rigs from their onlooker's perspective. This extends the opportunities for application of a head-mounted display.

The capture pose can be ascertained extrinsically or intrinsically, for example.

An intrinsic determination may be characterizable, for example, in that associated sensors are concomitantly moved and/or are aligned in the direction of the field of view and/or in that the field of view can be computed using on-board means of the head-mounted display. By way of example, it may also be recognizable from its not being able to be carried out when the head-mounted display is deactivated.

An extrinsic determination may be characterizable, for example, in that it can be carried out independently of or separately from an intrinsic determination. By way of example, it may also be recognizable from its being able to be carried out when the head-mounted display is deactivated.

The extrinsic determination can be carried out, for example, using the aforementioned markers and/or may be defined with respect to spatially fixed reference points.

The marker can be active. This permits individual detection of the individual head-mounted displays. Units can thus be easily swapped without retraining being required and/or the system having to be realigned. Definition of a single center as a reference for multiple encodings is thus also possible. This single center can then be used for mapping the virtual body to a field of view and ultimately for embedding without training for each marker.

The marker can alternatively or additionally also be passive. This permits the service life of the head-mounted display to be increased as fewer resources are consumed during operation. Markers can also be added in different positions on different head-mounted displays, thus permitting individual detection. A standardized mounting kit for connecting glasses and markers means that embedding is possible without training or with only very little effort. Another advantage of passive markers is their low weight, which has a positive effect on e.g. the wearing comfort of the head-mounted display.

In one configuration of the invention, there can be provision for means for intrinsically ascertaining a capture pose. This allows a virtual scene to be tracked on the basis of an intrinsically detected capture pose.

In this instance, there can be provision for means for matching the capture pose ascertained using the means for intrinsically ascertaining the capture pose with a preferably extrinsically ascertained further capture pose to be configured. This allows an intrinsically ascertained capture pose to be matched by means of an independent measurement, in particular an absolute value measurement. Errors that may result, for example from integration of detected changes (for example from an acceleration sensor and/or optical flow) to ascertain the intrinsic capture pose over longer distances or periods of time, can thus be compensated for or eliminated.

In one configuration of the invention, there can be provision for a preferably extrinsically ascertained capture pose to be able to be input. This allows comparison values or references for synchronizing an intrinsic ascertainment of a capture pose with a physical reality to be easily attained. By way of example, this can take place in addition to an intrinsically ascertained capture pose and/or matching with an intrinsically ascertained capture pose. The invention provides a combination of low latency concomitant conveyance of a virtual scene on the basis of an intrinsic capture pose with a more precise extrinsic ascertainment of a corresponding capture pose.

In one configuration of the invention, there can be provision for a means for displaying a virtual scene to be able to be controlled on the basis of the or a preferably extrinsically ascertained capture pose. This can permit easy synchronization of a virtual scene with a physical reality.

The stated object is achieved by, and a preferred application used is, a device for rendering at least one virtual object, having a head-mounted display according to the invention, in particular as described above or disclosed herein, having a 3D measuring device for extrinsically detecting the at least one marker. A system having redundant ascertainment is thus described that can be used to easily calibrate or reference measurement results.

In this instance, there can be provision for the means for matching to be fed from the 3D measuring device, preferably additionally from means for intrinsically detecting a capture pose. This permits a physical reality to be used as a reference in order to detect variances in an intrinsic ascertainment.

Preferably, a measurement accuracy of the 3D measuring device is greater than a measurement accuracy of the means for intrinsically ascertaining a capture pose.

The object stated at the outset is alternatively or additionally achieved by the use of a head-mounted display, in particular VR, XR and/or AR glasses, and a 3D measuring device, which is preferably stationary and/or operates independently of the head-mounted display, to produce a virtual view of a 3D model of an installation in the head-mounted display, individual virtual objects corresponding to real models detected by the 3D measuring device. There is thus the possibility of a means for virtually testing the function of an installation represented as a 3D model in a haptically controllable manner.

In particular, this can be used for testing the function of a preferably pharmaceutical installation, preferably in a method according to the invention, in particular as described above and/or below and/or disclosed herein, and/or in a device according to the invention, in particular as described above and/or disclosed herein. The invention can save considerable cost, time and space in this regard, since pharmaceutical installations, in particular as controlled spaces or in controlled spaces, for example RABS (restricted access barrier systems) or isolators, often have large spatial extents. This makes a traditional rig comprising cardboard and/or wood complex.

The object stated at the outset is alternatively or additionally achieved, according to the invention, by a method for visually displaying 3D data, wherein a field of view of a head-mounted display, in particular VR and/or XR and/or AR glasses, is intrinsically determined at recurring times and information that moves concomitantly with the field of view is displayed in the head-mounted display, a capture pose that predefines the field of view, preferably at recurring times, of the head-mounted display being ascertained and matched with the field of view. It is thus possible for the field of view to be embedded in a virtual world in a spatially accurate manner using the available computing capacities of a head-mounted display. The invention has the advantage that a spatial relation of the onlooker to virtual objects that are currently not in the field of view of the onlooker, defined by a capture pose of the head-mounted display, can also be ascertained.

The field of view of the head-mounted display in this instance may be determined for example by the field of vision of an onlooker whose head position corresponds to a current capture pose of the head-mounted display when said head-mounted display is in the use position. For example, the capture pose in this instance can refer to the position and attitude of a forward direction of the head-mounted display.

This method may, for example, be in the form of, or carried out as, a part of a method for testing the function of an installation according to the invention, in particular as described herein and/or disclosed herein.

In an advantageous configuration, there can be provision for the capture pose to be ascertained using a 3D measuring device that is configured independently of the head-mounted display and/or stationary. This permits the head-mounted display to be detected at all times and on all sides, and the field of view to be embedded without interruption.

By way of example, the 3D measuring device can comprise at least one or more cameras. In general, the use of multiple cameras can be said firstly to improve the accuracy of the measurement and secondly to be less susceptible to concealment of items by other items.

3D measuring devices are known per se for spatial detection of the position and attitude of real models. One possibility is to create two-dimensional images of the real models from different capture poses, to identify the respective models in these images, for example on the basis of added markers, and then to solve a system of equations that describes these images as shots of a common real model, the shape, for example the position of the individual markers, being included as an unknown and the image positions being treated as input variables. Alternatives to this are, for example, to use structured light, the pattern of which on the real models allows conclusions to be drawn about an attitude and a position of the real models. There are also known methods using propagation time measurements of signals.

In an advantageous configuration, there can be provision for the capture pose to be ascertained using a measuring device that moves concomitantly and/or is independent of the determination of the field of view. This reduces the equipment structure of the device according to the invention.

In an advantageous configuration, there can be provision for the intrinsic determination to be carried out using at least one concomitantly moving sensor, in particular a camera and/or a motion and/or acceleration and/or position sensor. This allows inherently known systems for ascertaining the field of view and the change therein with a head movement to be used.

In an advantageous configuration, there can be provision for the capture pose to be measured by means of active markers on the head-mounted display. Active markers afford the advantage of better distinguishability and easy changing of identifications.

In an advantageous configuration, there can be provision for the capture pose to be measured by means of passive markers on the head-mounted display. Passive markers help to save energy for operation, thus extending service life, while the device remains operational.

In an advantageous configuration, there can be provision for the capture pose to be measured by means of a stationary measuring device, in particular by means of stationary cameras.

In an advantageous configuration, there can be provision for the intrinsic determination of the capture pose to be measured by means of concomitantly moving cameras of the head-mounted display.

The object stated at the outset is alternatively or additionally achieved, according to the invention, by a method for visually displaying an installation and/or a method as part of a method described above and/or disclosed herein, wherein a field of view of a head-mounted display, in particular VR and/or XR and/or AR glasses, is intrinsically determined at recurring times and wherein an air flow is computed and visually displayed in the head-mounted display as preferably concomitantly moving 3D data. An advantage of this is that the influence of a work process on an air flow is immediately evident and/or controllable.

It is known to use air flows in controlled environments to prevent contaminants from transferring to areas requiring special protection. The invention permits said air flows to be checked, as air flows are also influenced, for example, by mobile functional units and/or a user.

In an advantageous configuration, there can be provision for the head-mounted display to be connected to a preferably stationary processing unit to transmit measurement data relating to the capture pose and/or image data for the head-mounted display. This permits computing routines to be transferred to stationary units with greater capacity. The data transmission in this instance can take place wirelessly or by wire, for example.

In an advantageous configuration, there can be provision for the 3D data to comprise a 3D model of an installation and/or for the 3D data to also comprise AR metadata for components of an installation, in particular the already mentioned installation. The use of a 3D model permits a realistic visual representation of an installation in the virtual space. The use of AR metadata additionally permits data that go beyond the mere image content, such as warnings, messages or instructions for action, to be shown or displayed. This makes it easy to change to an onlooker's language or permits shown information to be altered according to an operating state of the installation, for example. Flow data for an air flow can also be displayed as 3D data, in particular in the form of flowlines.

In an advantageous configuration, there can be provision for the head-mounted display, in particular a head-mounted display according to the invention, for example as described above and/or disclosed herein, to be used to produce an overlay on a real field of view with a virtual display of the 3D data. There is thus the possibility of MX or AR applications.

Alternatively or additionally, there can be provision for the head-mounted display, in particular a head-mounted display according to the invention, for example as described above and/or disclosed herein, to be used to shield a real environment. There is thus the possibility of VR applications.

Additionally, one of the described methods can have provision for a real model, for example one of the already mentioned real models, to be adjusted in motorized fashion. Setting to a position and/or an attitude of a virtual object can thus be carried out more easily and/or accurately.

Alternatively or additionally, one of the described methods can have provision for a real model, for example one of the already mentioned real models, to be adjusted, preferably in motorized fashion and/or automatically, until a preferably automatically detected variance in a position and/or an attitude of a virtual body from a corresponding virtual object is within a tolerance range. Automatic incorporation of a real model into the method can thus be achieved.

In the case of the shoulder rings described in more detail below, for example, these two configurations can be advantageously used together or each individually.

To achieve the object stated at the outset, there is also provision, according to the invention, for a device for visually displaying 3D data, having a head-mounted display designed to determine a concomitantly moving field of view, having a device for ascertaining a capture pose of the head-mounted display, and having a device for matching the capture pose with the field of view. There is thus the possibility of realizing spatially accurate embedding of a field of view in a virtual world of virtual objects with low computational requirements for the head-mounted display. This can be utilized for example for showing information and messages in the correct location.

In this instance, the device may, for example, be in the form of part of a device according to the invention for testing the function of an installation, for example as described above and/or disclosed herein.

An advantageous configuration may be configured to have a 3D engine for visually displaying the 3D data in the field of view. Known algorithms can thus be used to control visual representations.

An advantageous configuration may be configured to have a preferably stationary 3D measuring device for ascertaining the capture pose. A stationary 3D measuring device can be designed to have greater spatial coverage, for example by means of a spatial distribution of applicable cameras.

An advantageous configuration may be configured to have a device for generating a virtual space for a virtual body detected using a, for example the already mentioned, 3D measuring device. This allows real models and the changes therein to be detected. This can be used, for example, to connect a virtual world to a real world. An example of a 3D measuring device is the combination of the Prime^{X} 13 and/or Prime^{X} 13W cameras from OptiTrack (NaturalPoint, Inc., P.O. Box 2317, Corvallis, OR 97339) with the motion capture software Motive from OptiTrack.

An advantageous configuration may alternatively or additionally be configured to have a device for generating a virtual space for visually displaying the 3D data. This allows a scene to be provided for generating virtual visual impressions.

An advantageous configuration may alternatively or additionally be configured to have a device for establishing a correspondence between two virtual spaces, preferably the already mentioned virtual spaces, in particular for embedding the virtual bodies in the virtual space for the virtual display. This affords an easy-to-use means to alter virtual objects by manipulating real, corresponding models.

An advantageous configuration may be configured to have a device for embedding a field of view of the head-mounted display in the virtual space for the virtual display. This permits faithful visual representation of the virtual world in the eyes of an onlooker as though they were actually seeing the virtual world.

An advantageous configuration may be configured to have a device for computing an air flow, in particular for visually representing the air flow. Air flows can thus be made visible, in particular as flowlines.

To achieve the stated object, a method for testing the function of an installation is alternatively or additionally that the installation is represented as a virtual 3D model comprising virtual objects, wherein at least one virtual object provides a real model and that a virtual body is aligned with the real model at recurring times using a 3D position measurement and the at least one virtual object is linked to the virtual body and put into a desired positional relationship with the virtual body, the link between the virtual body and the at least one virtual object being altered by a user. The invention thus permits virtual modeling to be haptically tangible, which allows real function tests without requiring a complete real image of the installation to be tested. This can significantly simplify the function test, as the entire installation does not have to be set up as a real model. This can significantly simplify the function test, as the entire installation does not have to be set up as a real model.

The aforementioned links can be said in general to refer only to a subset of degrees of freedom of movement of the respective objects or bodies or to impose a complete definition. By way of example, a desired positional relationship can also mean that only parts of the movement are reconstructed (e.g. only X and Y axes, no rotation). This occurs for the hologram and also for the target (glove port).

By way of example, the real model may be tilted relative to the plane of a pane of glass, for example, and so when the link is activated an associated virtual object would be pulled out of the (virtual) plane of the pane. There can be provision here for a constraint to be formulated that allows this object to be aligned with respect to the virtual body only within certain degrees of freedom and fixes it within the degrees of freedom of the pane, so that the virtual object, for example a shoulder ring or a glove port, remains in the pane. Distracting visual impressions can thus be avoided.

By way of example, real objects that do not come into contact with a user in a specific test because they would be too far away can be dispensed with. In this instance, the concept of activating a link permits the virtual world to be coupled to the real world, for example, which makes items of the 3D model haptically tangible by means of suitably positioned real models. The concept of deactivating a link permits virtual objects to be swapped, for example, and thus a very limited stock of real models to be used multiple times, for example at different locations in an industrial installation, in particular if design items are used multiple times.

The user activating or deactivating the links may, for example, be an onlooker of the (virtual) installation, in particular a person performing a function test on the installation, or an assistant maintaining a 3D engine or generally software that implements the invention. By way of example, a 3D engine, also known as a graphics engine, may be characterizable as an integrated or externally stored program code responsible for computing the graphics interface in parallel with the actual program.

By way of example, a virtual object may be characterizable as a functional and/or design part of the 3D model. Examples may be static parts such as shoulder rings or boundary walls of an isolator as a special (pharmaceutical) installation or moving parts such as doors, in particular of transfer ports or rapid transfer ports (“rapid transfer system”, RTP for short, or alpha-beta port system) or transfer channels, or functional stations such as filling stations, closure stations, or material stores or manipulators. This list is not exhaustive. Other examples can be advantageously used.

By way of example, a virtual body may be characterizable as a rigid body formed from measuring points in a fixed arrangement in relation to one another.

By way of example, there can be provision for the link to be altered by activating (or starting) and/or deactivating (or terminating) it. This permits a spatial coupling between the virtual object and the virtual body in a virtual space to be established or released. Since the virtual body is coupled to a real model by way of the 3D position measurement, and the changes of attitude and position of said real model are forcibly reconstructed in a virtual space, the link can thus—in the case of activation—couple the virtual objects of the 3D model to reality or—in the case of deactivation—detach the virtual objects from reality.

In an advantageous configuration, there can be provision for the linking of the virtual body to the at least one virtual object to comprise the imposing of a desired positional relationship on a position and/or an attitude of the virtual object in relation to the virtual body. This allows the impression of a virtual object concomitantly moving with a haptically tangible real model to be created. This can be used, for example, to test real work steps on a 3D model for feasibility. This imposing, especially if limited in time, can also be used as a simple means of transferring a change in the real model, for example an ergonomic improvement, to the virtual object. The imposing can relate to all degrees of freedom of movement or to a subset of the degrees of freedom of movement, in particular to comply with constraints.

Generally, a position of a virtual object or a real model may be describable for example by three coordinates of a selected point, in particular a center of gravity, a center or another distinguished or special point. By way of example, an attitude of a virtual object or real model may be describable by angle specifications pertaining to an alignment with respect to rotations about the selected point to which the position refers, and/or by specifications relating to a position of another point on the virtual object or real model, which may be in a fixed relationship with the selected point. By way of example, a pose may be describable by a position and an attitude.

By way of example, there can be provision for the position and/or attitude of the virtual object to be set to the position and/or attitude of the virtual body. There is thus the possibility of realizing dislocation-free following or concomitant movement.

Alternatively or additionally, there can be provision for the imposing to be triggered by making a request. There is thus the possibility of swapping virtual objects and/or real models during the linking.

Alternatively, or additionally, there can be provision for the imposing to be carried out on an ongoing basis, for example at recurring times, preferably automatically. There is thus the possibility, for example, of having the virtual object concomitantly conveyed with the virtual body over a movement section.

In an advantageous configuration, there can be provision for the linking to be deactivated over a preferably defined or indeterminate period of time. This allows a real model to be aligned, in particular with respect to a further real model, the virtual body of which is already linked, in order to bring the real model into line with a virtual world, in particular the virtual 3D model, to which the at least one virtual object belongs in such a way that the further real model continues to be in line with this virtual world.

In this instance, there can be provision for variances between the at least one virtual object and the virtual body to be displayed when the link is deactivated. This can be used, for example, to take a real model to a desired position so that a desired reference to a virtual object is set up.

In an advantageous configuration, there can be provision for the link between the virtual body and the at least one virtual object to be replaced by another link between the virtual body and another virtual object. This permits a real model to be reused for a test on other virtual objects of the 3D model. Complete setup of the installation is thus not necessary. This can save space and time for creating the real models and permit the function test to be performed at remote locations or by users who are remote from one another. It also saves costs for production and assembly of the models. There are also technological advantages, for example comprehensibility can be improved by making a cut or showing a hologram in the virtual model.

In an advantageous configuration, there can be provision for the 3D model, when the link is replaced by another link, to be subjected to an isometric transformation until the virtual body and the other virtual object are in line at least within a tolerance range. This permits the user to move in the virtual world without the user having to change their location in the real world. This makes it easy to use already installed real rigs for further tests without conversion. It is then a simple matter to re-adjust the existing real models to the position and/or attitude of the new virtual objects as described above.

An isometric transformation such as this can comprise, for example, rotation and/or shifting. Relocation thus easily corresponds to any change of location in the real world.

Preferably, only isometric transformations that receive an orientation, that is to say for example do not mirror, are permitted. Changes for which there is no equivalent in the real world are thus blocked.

In an advantageous configuration, there can be provision for an attitude of the real model to be altered, preferably manually or automatically, until the associated virtual body is in line with the at least one virtual object or with the other virtual object. This permits the real models to be aligned in such a way that a haptic impression in interaction with the real model coincides with a visual impression when viewing the virtual object.

By way of example, a shoulder ring can initially be brought into line with the 3D model by activating a link to the virtual object in question. Subsequently, another shoulder ring or another part, for example a door or a functional unit to be manipulated, can be altered as a real model in such a way that this real model is brought into line with its corresponding virtual object and the real model positioned and/or aligned in this way is added to the virtual world.

In this instance, there can be provision for a link between the virtual body and the virtual object or the other virtual object to then be activated. A movement of the real model can thus then be reconstructed by the virtual object. It is thus possible to have an onlooker of the virtual world have the feeling of actually moving or manipulating the virtual objects, since the onlooker receives haptic or tactile sensory information matching the visual sensory information.

In an advantageous configuration, there can be provision for multiple virtual bodies to be linked to a respective virtual object of the 3D model, the individual links being altered, in particular activated and/or deactivated, independently of one another. This allows different real models, for example two shoulder rings, to be adjusted independently of one another, and/or individual real models can be selected as moving parts of the installation that require the virtual object to be concomitantly conveyed, while other real models are or remain able to be used as real-world reference points at which the virtual world can dock.

In an advantageous configuration, there can be provision for an update of coordinates of the at least one virtual object to be output. This can be used for example to edit design data relating to the 3D model. It is thus a simple matter to make adjustments and ergonomically and/or, in terms of the process, economically necessary changes to the installation without the need to create a new complete model in the real world.

In an advantageous configuration, there can be provision for it to concern an installation for the pharmaceutical sector, preferably for filling packets with drugs, and/or in combination with a protected space, preferably an isolator. Here, regulatory requirements and/or ergonomic constraints can be easily tested in workflows.

Alternatively or additionally, the stated object is achieved by a method for testing the function of an installation, wherein the installation is represented as a virtual 3D model comprising virtual objects, wherein at least one virtual object provides a real model and wherein a virtual body is aligned with the real model at recurring times using a 3D position measurement and the at least one virtual object is linked to the virtual body and put into a desired positional relationship with the virtual body, a real model that corresponds to the at least one virtual object being produced and provided with identifiable features, in particular markers, for a 3D position measurement, and a correspondence between the identified features and the at least one virtual object being stored. This permits items of the installation that are relevant to the tests and for which physical interaction is desired to be easily produced and incorporated. The identifiable features can be easily used to generate the virtual body that is to be linked to the object.

This aspect can advantageously be combined with the previously described aspect. By way of example, activation of the link allows a real model prepared for use by markers to be easily used in the method according to the invention. The markers may be realized, for example, by preferably two- or three-dimensional markers.

Preferably, the real model is produced in an additive method, in particular from CAD data or other data relating to the virtual object. This permits the 3D model to be realized in as accurate a detail as possible in order to make even details haptically tangible. An advantageous variant is also to use the real model and to provide said model with markers directly in order to achieve an even better haptic experience.

Alternatively, a virtual object can also be derived from a 3D scan of a real model. A prototype or a sample from a manufacturer can thus be used directly without the need for CAD data to be available, and/or a complex 3D print of a complex object can be avoided.

In an advantageous configuration, there can be provision for the identifiable features to be configured at predetermined positions in the real model. This permits quick and easy incorporation or creation of a correspondence between the virtual body, which may be determined by the features, and the virtual object on which the positions of the features may be recorded.

In an advantageous configuration, there can be provision for at least one position of the configured features on the real model to be measured. This can be done, for example, using a 3D camera. The measurement permits any markers to be added. This can simplify preparation of the real models for use.

In an advantageous configuration, there can be provision for an operator to wear a glove and/or a hand tracking device (smartglove, metaglove, motion capture glove, fingertracking device). Alternatively, direct tracking of hands is also possible. Detection of hands is favorable for rendering manipulation actions as realistically as possible in the virtual world. Isolator or shoulder gloves can also be used, for example to create a realistic replica of the resulting physical limitations.

There can be provision for a 3D position, in particular a position and an attitude, of one or more fingers and/or a hand and/or an arm to be recurrently determined. It is thus easy to integrate hands and/or arms that are used to carry out manipulations, and/or for which collision checks are required, into the virtual world.

By way of example, this may be realized by detecting a, in particular the already mentioned, glove and/or a, in particular the already mentioned, hand tracking device. Realistic manipulation actions can thus be virtually displayed.

In an advantageous configuration, there can be provision for the 3D model to represent a shoulder ring, to whose position a real shoulder ring is set, in particular in a preceding setup step, and/or for an operator to put an arm through the shoulder ring, preferably in a manipulation glove attached to the shoulder ring.

In an advantageous configuration, there can be provision for the capture pose of the onlooker to be defined relative to the shoulder ring. This allows the onlooker's position and attitude to be used as a reference for displaying the virtual objects.

In an advantageous configuration, there can be provision for the at least one virtual object to be a door of a transfer port or transfer channel. Other items of an installation that need to be manipulated during use can also be used, for example air samplers, agar plates, sampling equipment, filling stations, pump bodies, hoses, generally semi-stationary parts (for example whose mobility is restricted by joints or guides) or freely moving parts of the installation.

In general, the real models can be divided into those that move with respect to a reference point, for example a boundary of the installation, and/or with respect to an access point, in particular with respect to a shoulder ring, and those that do not move.

In an advantageous configuration, there can be provision for the 3D model to have a further virtual object for which a further real model is provided, the real model being arranged so as to move relative to the further real model. This allows individual real models to be used as reference points for connecting the virtual world, and other real models to be used for spatially accurate manipulations in a virtual world brought to register with reality.

In an advantageous configuration, there can be provision for at least part of the further real model not to move and/or at least part thereof to move in relation to a demarcation of the installation. This allows a demarcation to be used as a reference point or reference surface in order to produce a correspondence between the virtual world and the real world.

A non-exhaustive list of examples of at least partially moving components of an installation that are advantageously able to be used as a real model comprises a shoulder ring and/or a door frame of a transfer port and/or a door, in particular from a transfer port, or a transfer channel door, and/or a latch and/or a petri dish, an air sampler, at least one agar plate, a sampling, a pump body, at least one hose.

A configuration of potentially independent inventive quality proposes achieving the stated object by way of a method for testing the function of an installation, in particular as described above, having the following steps: providing CAD data relating to the installation, creating at least one real model for at least some of the CAD data, installing the at least one real model in a 3D measuring device, displaying a virtual 3D model, created from the CAD data, by processing at least 3D measurement data of the 3D measuring device. This permits the function of a complex installation to be tested, based on haptic impressions of the real model, with low material costs.

In an advantageous configuration, there can be provision for a field of view of a head-mounted display to be determined, preferably using the 3D measuring device. This permits an observer and/or operator to be embedded in a virtual scene of virtual objects of the CAD model.

In an advantageous configuration, there can be provision for the 3D model to be displayed with respect to a field of view of a head-mounted display. This permits the 3D model to be realistically viewed from an onlooker's position.

In an advantageous configuration, there can be provision for a change on the at least one real model to be automatically reconstructed on the 3D model. This allows changes in the real world to be easily reconstructed in the virtual world in which the 3D model is defined. An onlooker can thus be given the impression that the virtual objects can be altered by means of-haptically tangible-alteration of the associated real model, for example which corresponds to the linked virtual body. This permits function tests on complex industrial installations such as pharmaceutical installations to be carried out with little use of materials, time and space.

Here or in general, there can be provision for modified design data to be generated and output from the altered 3D model or altered virtual objects. This permits design changes that have arisen during the function test to be specified.

In an advantageous configuration, there can be provision for the 3D measuring device to be transported in a fixed test rig prior to being installed. This allows a device according to the invention to be easily transported to a remote location, for example for a function test in situ.

The object stated at the outset is alternatively or additionally achieved by means of a device for testing the function of an installation, the installation existing as a virtual 3D model, having a 3D measuring device, at least one real model of a virtual object of the 3D model, a device for automatically incorporating a virtual body detected for the real model using the 3D measuring device into the 3D model, a device for automatically concomitantly conveying the virtual object with the virtual body and a device for visually displaying the 3D model, in particular a 3D engine. Means are thus provided to test a haptically tangible, virtually representable installation.

In an advantageous configuration, there can be provision for a means for activating and/or deactivating a link between the virtual body and the at least one virtual object to be configured. This allows an operator to easily define how the virtual world of the 3D model is meant to be associated with reality.

In an advantageous configuration, there can be provision for a head-mounted display to be designed to produce a field of view on the 3D model. This allows a natural onlooker's position to be realized.

In an advantageous configuration, there can be provision for a device for producing a field of view on the 3D model to be fed with measured values from the 3D measuring device in relation to a, in particular the already mentioned, head-mounted display. This permits the 3D model to be viewed from a human observer's position.

In an advantageous configuration, there can be provision for a device for isometrically transforming the 3D model relative to the field of view to be configured. This permits relocation of the 3D model or a virtual change of position by an operator of the installation.

An advantageous configuration may be configured to have means for carrying out a method according to the invention, in particular as described above and/or disclosed herein. This indicates a way of performing the described methods.

In an advantageous configuration of one of the described devices, there can be provision for the device to be configured to have a device for adjusting at least one real model in motorized fashion. This permits precise and/or automatic and/or remotely triggered adjustment.

Alternatively or additionally, an advantageous configuration of one of the described devices can have provision for the device to be configured to have a device for preferably automatically determining a variance in a position and/or attitude of a virtual body from a corresponding virtual object. This allows incorporation to be supported in a computer-aided manner.

Alternatively or additionally, an advantageous configuration of one of the described devices can have provision for the device to be configured to have a device for adjusting at least one real model in motorized fashion until a preferably automatically detected variance in a position and/or an attitude of a virtual body from a corresponding virtual object is within a tolerance range. This allows fully automatic or semi-automatic incorporation of real models to be attained.

Alternatively, or additionally, an advantageous configuration of one of the described devices can have provision for the device to be configured to have a device for collision checking for a virtual light beam. This can permit simulation of a light barrier, for example a light grid. By way of example, the 3D model may have the associated light barrier modules stored as virtual objects, and the light beam is automatically generated and monitored on the basis of the attitude and position of the light barrier modules.

### BRIEF DESCRIPTION OF THE DRAWINGS

The invention is now described in more detail with reference to exemplary embodiments, but is not limited to the exemplary embodiments. Other exemplary embodiments are obtained by combining one or more of the features disclosed herein with one another and/or with single or multiple features of the exemplary embodiments.

In the drawing:

FIG. 1 shows a head-mounted display according to the invention and the use of said display in a device for visually displaying 3D data,

FIG. 2 shows a highly schematized depiction of a device for testing the function of an installation with a head-mounted display and with a device for visually displaying 3D data,

FIG. 3 shows a more realistic individual depiction of a real model of the device according to FIG. 2 with two adjustable shoulder rings and a 3D measuring device,

FIG. 4 shows another more realistic depiction of the arrangement according to FIG. 3 in a view of a glove from the side,

FIG. 5 shows another more realistic individual depiction of a real model of the device according to FIG. 2 with a moving door,

FIG. 6 shows re-adjustment of a virtual object of a 3D model of the device according to FIG. 2 to achieve a desired positional relationship and to produce a connection,

FIG. 7 shows alteration of a real model in a device according to FIG. 2 to obtain a desired positional relationship with respect to an associated virtual object and to produce a link,

FIG. 8 shows a schematic depiction of a 3D model in different alignments for a virtual change of location by an onlooker,

FIG. 9 shows a plan view of a detailed depiction of a 3D model of a pharmaceutical installation, and

FIG. 10 shows a schematic depiction of matching of an intrinsically ascertained capture pose and an extrinsically ascertained capture pose for synchronizing a depiction of a concomitantly conveyed virtual scene.

### DETAILED DESCRIPTION

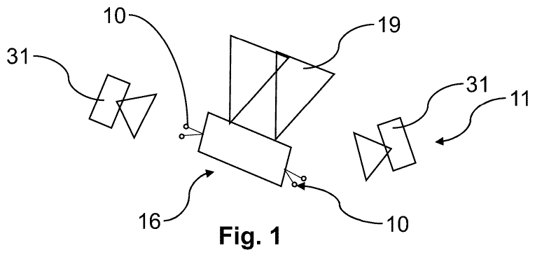

FIG. 1 shows a device for testing the function of an installation, said device being denoted as a whole by 1.

A virtual 3D model 2 of an installation 1 is composed of virtual objects 3, 4 and provided in a first virtual space 5.

The virtual 3D model 2 in this instance is derived from CAD data for an industrial installation, which are not shown further.

This installation is shown with the virtual objects 3 and 4 only very schematically in order to outline the operating principle of the method according to the invention.

In fact, the installation comprises many more components. A preferred application of the invention provides for the installation to be a pharmaceutical installation that may be intended, for example in a protected space or an isolator, for carrying out specific methods, for example repackaging/packaging drugs or assembling dispensing equipment for medical preparations.

The first virtual space 5 contains a large number of virtual objects 3, 4. Further virtual objects 63 may also be present.

Some of these virtual objects 3, 4 have corresponding real models 7, 8 installed in a real space 6. No real models are installed for the further virtual objects 63.

These real models 7, 8 are mounted on special stands 9 so that they remain at a desired position in the real space 6.

These stands 9 are not part of the virtual 3D model 2 because the virtual objects 3 and 4 therein are mounted on other design items, for example glass walls or boundary walls or tables. These glass walls, boundary walls and tables are not present in the real space 6, however.

The real models 7 and 8 are additionally equipped with additional markers 10, which have no equivalent in the virtual objects 3 and 4.

These markers 10 are intended for position and attitude detection by a 3D measuring device 11 that is installed in the real space 6. The 3D measuring device 11 detects these markers 10 and establishes the position thereof in a second virtual space 12. The virtual objects 3 and 4 are not present in this second virtual space 12, therefore, but rather only positions of the markers 10, which are combined to form virtual bodies 13, 14 depending on which real models 7, 8 they are mounted on.

Between the first virtual space 5 and the second virtual space 12 there is an established correspondence 15 that associates spatial points in the first virtual space 5 with corresponding spatial points in the second virtual space 12, and vice versa.

A head-mounted display 16 is additionally arranged in the real space 6, for example on the head of a user, who is not shown further.

This head-mounted display 16, for example VR glasses, is not necessarily represented in the virtual 3D model 2, but also has markers 17 to detect its attitude and position in the real space 6 and display it in the second virtual space 12.

In other words, there is in the second virtual space 12 a virtual body 18 that represents the head-mounted display 16 by way of the markers 17.

The head-mounted display 16 generates a field of view 19 in a manner known per se to create a visual 3-dimensional impression for the user. This visual impression 20 is computed from the measured attitude and position, that is to say the capture pose, of the head-mounted display 16 and the attitude and position of the virtual objects 3 and 4 on the basis of the aforementioned correspondence 15.

The virtual objects 3 and 4 are used for the visual impression 20 in this instance, and so for example the stand 9 and also the markers 10, 17 are not displayed.

The field of view 19 of the head-mounted display 16 in this instance is defined by a worn position of the head-mounted display 16 on the head of a user and the natural field of vision thereof.

To create the visual impression 20, the field of view data 21, the position and attitude data 22 from the second virtual space 12 and the object data 23 from the first virtual space 5 are schematically processed together in a manner known per se in FIG. 1.

To determine the field of view 19, the head-mounted display 16 may be equipped with its own sensors 46, which are not shown further here.

For example, the head-mounted display 16 may be equipped with a number of cameras that detect the field of vision of a user of the head-mounted display 16 and take spatial features such as edges and room corners and the like as a basis for computing a position and an attitude of and/or a change in these values. For this purpose, it is technically known practice to equip the head-mounted display 16 itself with appropriate computing capacity so that no external computing capacity is required.

Since the real models 7 and 8 are installed in the real space 6, a user in the real space 6 can feel these real models 7 and 8 by touch, even if the head-mounted display 16 is of VR glasses type and thus prevents the real models 7, 8 from being looked at.

In order to achieve correspondence between this haptic impression and the visual impression 20, the real models 7 and 8 were initially aligned with their associated virtual objects 3 and 4.

The method according to the invention now permits a link 24 to be activated between the virtual objects 3 and 4, on the one hand, and the corresponding virtual bodies 13, 14, on the other. As a result of this link 24, the virtual object 3, 4, in the example the virtual object 4, is concomitantly moved with the virtual body 13, 14, in the example the virtual body 14, on the basis of the correspondence 15.

Accordingly, if the real model 8 is altered by a movement 25, this movement 25 is reproduced in the second virtual space 12 by the 3D measuring device 11.

The situation with regard to direct following can also be changed so that only some axes follow along and some are “fixed”, for example to satisfy constraints, as already mentioned. The link 24 now causes the virtual object 4 in the first virtual space 5 to move in the same way according to the correspondence 15.

This leads to an apparent movement 26 in the visual impression 20.

The user producing the movement 25 by manipulating the real model 8 thus obtains the impression that, due to the manipulation, the virtual object 4 is performing an apparent movement 26.

If the link 24 is deactivated by the user or another person, manipulation of the real model 8 does not result in a change in the visual impression 20. This can be decided for the objects individually; it does not necessarily have to be so everywhere.

A head-mounted tracking device 27 is additionally arranged in the real space 6. The aforementioned user wears this head-mounted tracking device 27 like a glove to carry out the aforementioned manipulation on the real models 7, 8. Markers 28 on the head-mounted tracking device 27 are also represented by the 3D measuring device 11 as a virtual body 29 in the second virtual space 12, and so a replicated hand 30 appears in the visual impression 20.

The head-mounted display 16 can be connected wirelessly or by wire to a preferably stationary processing unit to transmit measurement data relating to the capture pose and/or image data for the visual impression 20.

A 3D engine, not shown further, is used to create the visual impression 20. Said engine forms a device for producing a field of view on the 3D model 39. A device for isometrically transforming the 3D model 39 relative to the field of view 19 operates on the first virtual space 6, as is explained more precisely below with reference to FIG. 8.

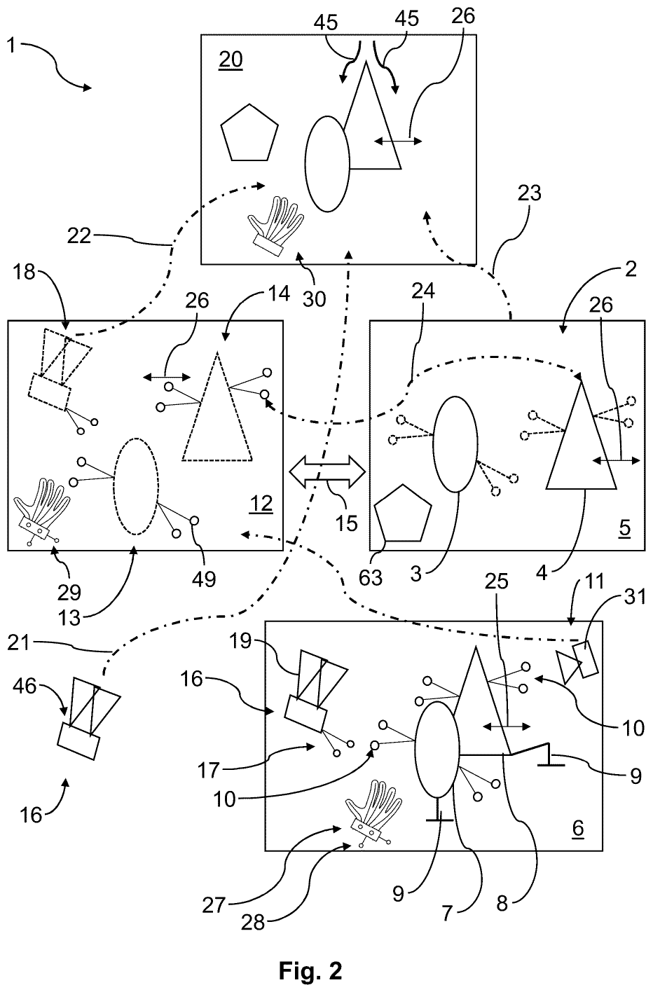

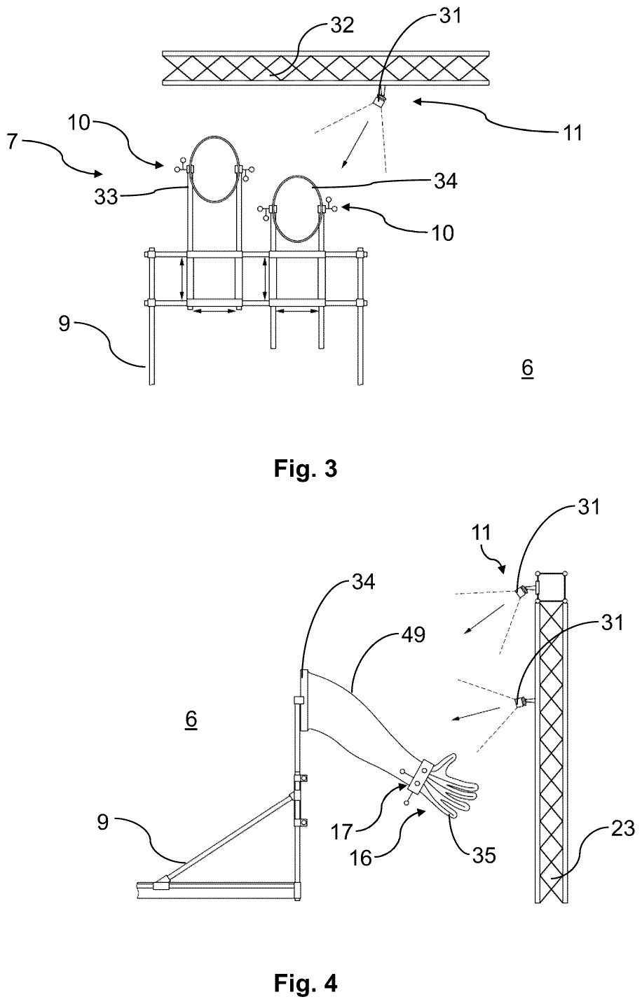

FIG. 2 shows a somewhat more realistic depiction of the real model 7 from FIG. 1 in a view from the front, and FIG. 3 shows this arrangement from the side.

Only sections of the 3D measuring device 11 are shown in both depictions.

In fact, the real space 6 typically contains three or even more than five cameras 31 arranged on a special supporting structure 32.

The position and attitude of this camera 31 is precisely known.

In order to facilitate erection in situ, there can be provision for the fully assembled supporting structure 32 to be brought to the site of use in a container or in entirely packaged form. In this regard, the invention affords the advantage that it is not necessary to transport a model construction of the installation. Rather, the erected supporting structure 32 can be used as a mobile test rig.

The real model 7 has two shoulder rings 33, 34, as are known from isolators for attaching isolator gloves 49. The shoulder rings 33, 34 are often configured in glass walls in the installation. The position of the shoulder rings 33, 34 thus clearly shows a position of a boundary of the installation, for example of a protected or controlled space.

The position of these shoulder rings 33, 34 on the stand 9 can be adjusted horizontally and vertically.

The hand tracking device 27 is connected to one of the shoulder rings 33, 34 for forming an isolator glove 49.

The other shoulder ring 33, 34 can have a hand tracking device 27 for another hand of the user in a similar manner. During use, the user thus positions themselves in front of the shoulder rings 33, 34 and puts each of their two arms into one of these shoulder rings 33, 34 in order to use their hands to operate the respective hand tracking device 27.

In other exemplary embodiments, instead of the hand tracking device 27, detection of the attitude and position, or shape, of the hand of the user is accomplished by way of optical recognition algorithms.

The shape of the hand can also be detected by way of special sensors in the fingers 35, which will not be discussed further here.

For example, head-mounted tracking devices 27 in the form of “Quantum” METAGLOVES from Manus, Floor 9, Kennedyplein 200, NL-5611 ZT Eindhoven, are known and usable.

FIG. 4 shows a more realistic depiction of the real model 8 from FIG. 1.

It can be seen that the real model 8 consists of a moving part 36 and a stationary part 37.

The depiction shows an example of a door 47, as can be used on a wall of an isolator, for example as a transfer port 48 or as a rapid transfer port or for a transfer channel.

The items of this door 47 are insignificant for explaining the invention; it is merely important that this transfer port 48 has a moving part 36 and a stationary part 37.

This moving part 36 can be gripped and opened by the user to perform the movement 25 mentioned in relation to FIG. 1.

This leads to the visual impression 20 showing a change in the associated multipartite virtual object 4 that corresponds to a door 47 being opened.

The user can thus, for example, check whether they can reach and operate a door 47 in an isolator through the shoulder rings 33, 34.

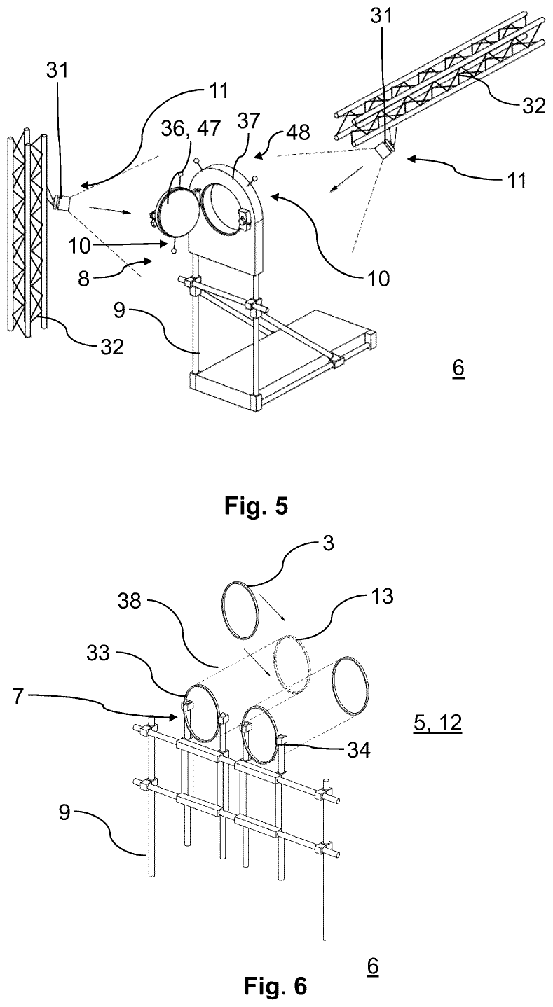

FIG. 5 shows the setup of the already mentioned link 24 using the example of the shoulder rings 33, 34.

This setup is carried out before the user begins the scheduled tests, in order to exactly coordinate the shoulder rings 33, 34 with their virtual equivalents.

The Figure shows the real model 7 in the front row, behind that an associated virtual body 13, shown in dashed lines, and the associated virtual object 3, shown in solid lines.

This depiction has been chosen for simplicity. In fact, the real model 7, the virtual object 3 and the virtual body 13 are in different spaces 6, 12, 5.

The projection lines 38 between the real model 7 and the virtual body 13 are intended to symbolize the 3D measurement by way of the 3D measuring device 11.

When a request is made, the virtual object 3 is taken to a position that corresponds to the position of the virtual body 13 by way of the correspondence 15.

To support this process, there can be provision for both the virtual body 13 and the virtual object 3 to be rendered in the visual impression 20.

In FIG. 5, this process is already completed for the right shoulder ring 34.

Making said request thus imposes a desired positional relationship on the position and attitude of the virtual object 3 in relation to the virtual body 13.

FIG. 6 shows the real model 7 in the foreground and the associated virtual object 3 in the background.

The projection lines 38 again illustrate the action of the 3D measuring device 11.

To simplify the depiction, the virtual body 13 is not shown.

In the visual impression 20, the user now sees that the virtual object 3 and the virtual body 13, which is also shown, are not situated above one another.

The user or an assistant can now alter the stand 9 in such a way that the virtual body 13 is situated above the virtual object 3. The link 24 can then be activated. Compared with the approach according to FIG. 5, this approach has the effect that the virtual object 3 is not altered by the activation of the link 24 and remains unchanged in particular with respect to other virtual objects 4.

Since the shoulder rings 33, 34 remain stationary, it is not necessary to activate the link 24, but rather it may be permanently deactivated.

The formation of individual links 24 between the virtual body 14 and the virtual object 4 allows the individual links 24 to be permanently deactivated for individual virtual bodies 13, 14. This permits such adjustments to be made independently of the other virtual objects 3, 4.

The real model 7 in this instance can be adjusted in motorized fashion, for example until an automatically detected variance 64 in a position and/or attitude of a virtual body 13, 14 (not shown, cf. FIG. 5) from a corresponding virtual object 3 is within a tolerance range.

For this purpose, the device shown has a device for adjusting at least one real model 7, 8 in motorized fashion and a device for preferably automatically determining a variance 64 in a position and/or an attitude of a virtual body 13, 14 from a corresponding virtual object 3, 4 and a device for adjusting at least one real model 7, 8 in motorized fashion until an automatically and/or manually detected variance 64 in a position and/or an attitude of a virtual body 13, 14 from a corresponding virtual object 3, 4 is within a tolerance range.

FIG. 8 shows a schematic depiction of a 3D model 39 of an industrial installation, for example a pharmaceutical installation.

The 3D model here has a wall 40 in which, as an example, three access points 41, 42, 43 are arranged.

Each of these access points 41, 42, 43 in this instance can include, for example, virtual equivalents of pairs of shoulder rings 33, 34.

The left-hand depiction in FIG. 8 shows a position in which a real model 7 of the access point is brought into line or put into a desired positional relationship with the virtual equivalent using a method according to FIG. 6 or 5.

This state is used to test and verify the accessibility of the installation that to the 3D model 39 through this access point 41.

If another access point 42, 43 is now meant to be tested, the 3D model 39 can be isometrically transformed in particular relative to the virtual body 13 such that the further access point 42 can be brought into line with the real model 7, or the virtual body 13 thereof. This alters the attitude of the 3D model 39 in the first virtual space 6 or the correspondence 15 between the first virtual space 6 and the second virtual space 12. The installation can now be tested through this access point 42. This situation is illustrated in the middle part of the image in FIG. 8.

The right-hand part of the image shows a further real model 44 that may be installed in a separate real space 6 or in the same real space 6.

This further real model 44 thus has a further virtual body 14 that is generated either by way of the same 3D measuring device 11 or by way of a further 3D measuring device 11 if the further real model 44 is installed in another (real) space.

In this way, it is possible for the installation to be tested by two users at the same time, without the need for these users to be in any real spatial relationship with one another.

These two users can e.g. perform a (virtual) handshake or check handovers or mutual handicaps.

When switching from the left-hand situation to the middle situation in FIG. 8, the link 24 between the access point 41 as a virtual object and the virtual body 13, 14 of the real model 7 is thus deactivated, in order to replace it with a link 24 of the same virtual body 13 to another access point 42 as a virtual object. When the link 24 is produced in this case, there is a predefined tolerance range within which a link 24 is accepted without the virtual object 3 having to be altered.

The users can now check, for example, the packaging of drugs in the protected space, here an isolator.

The rig discussed can thus be used to carry out a method for testing the function of an installation made up of the virtual 3D model 39 with a multiplicity of virtual objects 3, 4, each selected virtual object 3, 4 being provided with as realistic a real model 7, 8 as possible. For example, these real models 7, 8 are produced as a 3D print from the virtual objects 3, 4. The similarity in this instance is meant to be so concordant that an optical impression when touching the real model 7, 8 is concordant with a visual impression when viewing the virtual object 3, 4.

The 3D measuring device 11 now measures the real models 7, 8 at recurring times in order to align an associated virtual body 13, 14 accordingly in the second space 12.

This involves the real models 7, 8 being provided with markers 10 to permit identification on the basis of features. To permit the virtual objects 3, 4 to be concomitantly conveyed, provided that a link 24 is activated, correspondences 15 between these identified features, that is to say the markers 10, and the virtual objects 3, 4 are stored, and so virtual bodies 13, 14 can be moved with virtual objects 3, 4.

The virtual objects 3, 4 in this instance can contain predetermined positions, for example drill holes, at which the markers 10 are added. This permits the markers 10 to be easily arranged at positions on the real models 7 and 8 so that the virtual body 13, 14 can be easily found and aligned with respect to the virtual object 3, 4.

Alternatively, the markers 10 can also be put onto the real models 7, 8 as desired, and a position of the configured features, in particular the markers 10, on the real model 7, 8 can then be measured.

The method for testing the function of an installation 1 can therefore begin by initially providing CAD data relating to the installation by means of appropriate design, processing these CAD data to produce a 3D model 39, generating real models 7, 8 for this 3D model 39, or for some of the CAD data, for selected items, in particular using 3D printing or an alternative manufacturing method, installing these real models 7, 8 in a 3D measuring device 11, and displaying the 3D model 39 in the visual impression 20 from the onlooker's position.

If the test requires changes to the 3D model 39, for example according to the approach from FIG. 5, these changes to the 3D model 39 can be output as modified design data at the conclusion of the test. This may be the case, for example, if certain items of the 3D model 39 have been found to be ergonomically unfavorable and therefore need to have their design revised.

In the course of testing, users can now perform any manipulations on the real models 7, 8 to check the effects thereof on the visual impression 20 at the level of the virtual objects 3, 4.

This is made possible by the link 24, which compels the virtual objects 3, 4 to be concomitantly conveyed with the associated virtual bodies 13, 14. In the presented exemplary embodiment, this is achieved using a device for automatically concomitantly conveying the virtual objects 3, 4 with the associated virtual body 13, 14 and a 3D engine as a device for visually displaying the 3D model 39.

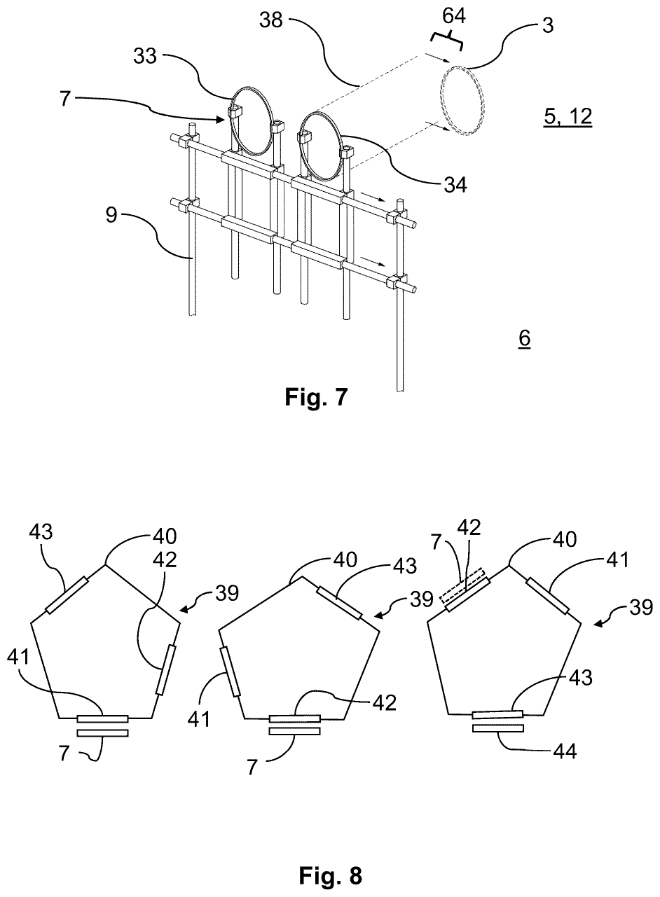

FIG. 7 shows a head-mounted display 16 in a schematic depiction with a 3D measuring device 11. This rig can be used for the rig according to FIG. 1, but can also be operated separately from the rig according to FIG. 1.

This head-mounted display 16 involves the attitude and alignment of the field of view 19 being determined at recurring times, with concomitantly moving information, for example virtual objects 3, 4 in the manner described or other location-related information such as warnings or work instructions, being shown, for example in the visual impression 20.

This involves the field of view 19 being ascertained using intrinsic, that is to say, for example, integrated, means of the head-mounted display 16. The result of this is that this field of view 19 can be created only with respect to real models 7, 8 situated in the field of view 19.

To also permit the head-mounted display 16 to be aligned with respect to the other real models outside the field of view 19, the 3D measuring device is used to extrinsically ascertain an attitude and a position of the head-mounted display 16 on the basis of markers 10. This information can then be associated with the field of view 19 to permit precise and almost uninterrupted or completely uninterrupted detection of an attitude and a position of the head-mounted display 16 and thus a continuous visual experience in the visual impression 20.

Controlled air flows are known to often be used in isolators in controlled environments, inter alia, in order to be able to discharge potentially occurring contaminants in a controlled manner and to keep sensitive areas free of contaminants.

The present invention now permits such air flows to be computed as flowlines and the change therein, in particular with movements 25, to be displayed in the visual impression 20.

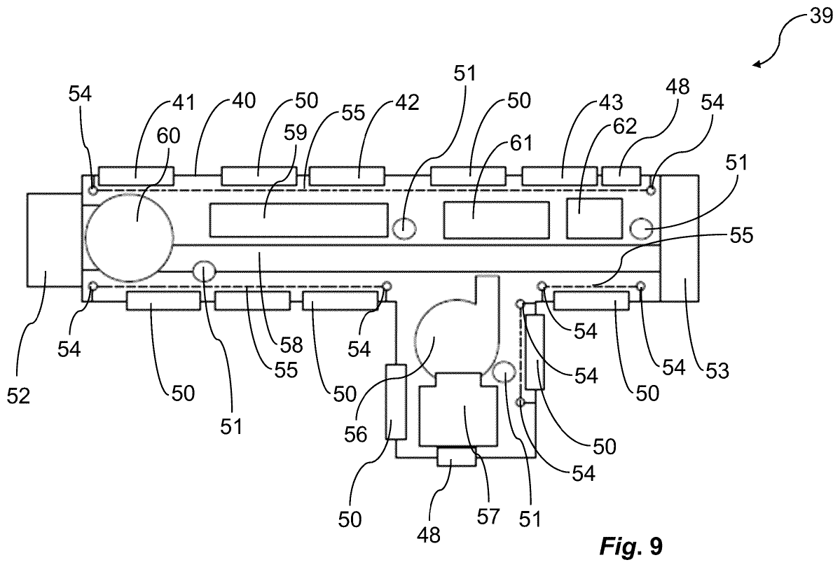

FIG. 9 shows a further virtual 3D model 39 for use in the invention. This is a pharmaceutical installation having a wall 40, access points 41, 42, 43, 50, measuring stations 51, for example for measurement using agar plates and/or by means of particle measurement, a feed 52 from an automation, a discharge 53 to a further automation, light barrier modules 54 having light beams 55 for monitoring the access points 41, 42, 43, 50 for unexpected and/or unauthorized access, a sorting pan for providing stoppers or other components of packaging or medical dispensing equipment in the correct position, a material supply 57 for the sorting pan 56, which is refillable via a transfer port 48, for example, a transport and processing area 58, for example for processing (filling and sealing) containers (vials, etc.), a filling station 59 for filling containers, a separating station 60 for separating packets from containers supplied by the feed 52, a fitting station 61 for sealing the containers with the aforementioned stoppers, and a control station 62 for checking the filled and sealed containers.

Some of the components require haptic contact with a user during a function test and are therefore used as a real model 7, 8. For example, this is not required for the sorting pan 56—a virtual object 63 is sufficient here. On the other hand, it is advantageous to use a real model 7, 8 for the filling station 59 and the measuring stations 51. This can be an actual product instead of the 3D print already described. This can be easier for complex rigs.

The light barrier modules 54 may also be present as real models 7, 8, but in functionless form, for example. The light beam 55 is simulated in the virtual world and a check is performed to establish whether a user virtually interrupts the light beam 55 and, if applicable, generates a signal.

In a method for testing the function of an installation 1, it is therefore proposed that real models 7, 8 be created from items of a virtual 3D model 39 of the installation, the spatial position and attitude of which models is detected using a 3D measuring device 11 during the function test, these determined attitudes and positions being able to be used to concomitantly convey virtual objects 3, 4 of the 3D model 39 in order to display a visual impression 20 in a virtual reality concomitant conveyance for manipulation on the real models 7, 8.

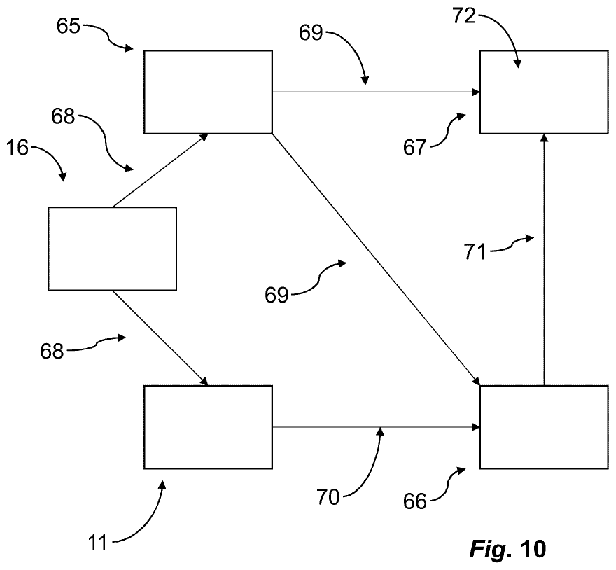

FIG. 10 shows a schematic plan for synchronizing a concomitantly conveyed virtual scene. A head-mounted display 16, for example as described above, has means for intrinsically ascertaining a capture pose 65. For example, an acceleration sensor may be designed for this purpose in a manner known per se, or an optical flow in a recorded video sequence can be evaluated. Typically, a method is implemented in which changes in the capture pose are detected and integrated to produce a capture pose.

The intrinsically ascertained capture pose 69 is transmitted to means for displaying 67 of the head-mounted display 16 in order to concomitantly convey a virtual scene 72 with a movement of the head-mounted display 16.

A 3D measuring device 11 is used to extrinsically ascertain a capture pose 70. These are fed to means for matching 66.

The means for matching 66 additionally receive the intrinsically ascertained capture pose 69. If the variance is too large, and/or in response to a timed or manual stipulation, synchronization 71 for the means for displaying 67 is generated in order to coordinate or associate the virtual scene 72 with the extrinsically detected capture pose 70.

In another embodiment, which is not shown, the 3D measuring device (or a portion thereof) is attached to the head-mounted display 16. In this instance, the markers or other tags may, for example, be in a fixed arrangement in space as reference points. This also results in there being a combination of an extrinsic measurement of the capture pose with an intrinsic measurement of a capture pose.

In a head-mounted device 16, it is thus proposed that at least one marker 10, 17 be configured or added on the outside in order to permit a capture pose of the head-mounted device 16 (FIG. 1).

### LIST OF REFERENCE SIGNS

1 device for testing the function of an installation
2 virtual 3D model
3 virtual object
4 virtual object
5 first virtual space
6 real space
7 real model
8 real model
9 stand
10 marker
11 3D measuring device
12 second virtual space
13 virtual body
14 virtual body
15 correspondence
16 head-mounted display
17 marker
18 virtual body
19 field of view
20 visual impression
21 field of view data
22 position and attitude data
23 object data
24 link
25 movement
26 apparent movement
27 hand tracking device
28 marker
29 virtual body
30 replicated hand
31 camera
32 supporting structure
33 shoulder ring
34 shoulder ring
35 finger
36 moving part
37 stationary part
38 projection line
39 3D model
40 wall
41 access point
42 access point
43 access point
44 further real model
45 flowline
46 sensor
47 door
48 transfer port
49 isolator glove
50 further access point
51 measuring station
52 feed
53 discharge
54 light barrier module
55 light beam
56 sorting pan
57 material supply
58 transport and processing area
59 filling station
60 separating station
61 fitting station
62 control station
63 further virtual object
64 variance
65 means for intrinsically detecting a capture pose
66 means for matching
67 means for displaying
68 change of position
69 intrinsically detected capture pose
70 extrinsically detected capture pose
71 synchronization
72 virtual scene

1. A method of producing a virtual view of a 3D model (39) of an installation in a head-mounted display (16), the method comprising: producing a virtual view of a 3D model (39) of an installation in the head-mounted display (16) using a 3D measuring device (11) that is stationary and/or operates independently of the head-mounted display (16), with the virtual view of the 3D model (39) having individual virtual objects (3, 4) corresponding to real models (7, 8) detected by the 3D measuring device (11).

2. A method for visually displaying 3D data, the method comprising intrinsically determining a field of view (19) of a head-mounted display (16), at recurring times and displaying information that moves concomitantly with the field of view (19) in the head-mounted display (16), and ascertaining and matching a capture pose that predefines the field of view (19) of the head-mounted display (16) with the field of view (19).

3. The method as claimed in claim 2, wherein the capture pose is ascertained using a 3D measuring device (11) comprising at least one or more camera (31), that is configured independently of the head-mounted display (16) and/or is stationary.

4. The method as claimed in claim 2, wherein the capture pose is ascertained using a measuring device that moves concomitantly and/or is independent of the determination of the field of view (19).

5. The method as claimed in claim 2, further comprising carrying out the intrinsic determination using at least one concomitantly moving sensor.

6. The method as claimed in claim 2, further comprising measuring the capture pose using active markers (10, 17) on the head-mounted display (16).

7. The method as claimed in claim 2, further comprising measuring the capture pose using passive markers (10, 17) on the head-mounted display (16).

8. The method as claimed in claim 2, further comprising measuring the capture pose a stationary measuring device.

9. The method as claimed in claim 2, further comprising measuring the intrinsic determination of the capture pose i using concomitantly moving cameras (31).

10. A method for visually displaying an installation, the method comprising: intrinsically determining a field of view (19) of a head-mounted display (16) at recurring times; and computing and visually displaying an air flow in the head-mounted display (16) as concomitantly moving 3D data.

11. The method as claimed in claim 10, wherein the 3D data comprise a 3D model (39) of an installation and/or wherein the 3D data comprise AR metadata for components of the installation.

12. The method as claimed in claim 10, wherein the head-mounted display (16) is used to produce an overlay on a real field of view (19) with a virtual display of the 3D data or to shield a real environment.

13. A method for testing a function of an installation, wherein the installation is represented as a virtual 3D model (2) comprising virtual objects (3, 4), the method further comprising: providing a real model (7, 8) for at least one of the virtual objects (3, 4); aligning a virtual body (13, 14) with the real model (7, 8) at recurring times using a 3D position measurement and linking the at least one virtual object (3, 4) to the virtual body (13, 14) and putting the at least one virtual object (3, 4) into a desired positional relationship with the virtual body (13, 14), and a user altering the link (24) between the virtual body (13, 14) and the at least one virtual object (3, 4).

14. The method as claimed in claim 13, wherein the linking (24) of the virtual body (13, 14) to the at least one virtual object comprises imposing of a desired positional relationship on a position and/or an attitude of the virtual object (3, 4) in relation to the virtual body (13, 14).

15. The method as claimed in claim 14, further comprising deactivating the linking (24) over a period of time so that variances between the at least one virtual object and the virtual body (13, 14) are displayed when the link (24) is deactivated.

16. The method as claimed in claim 15, Further comprising replacing the link (24) between the virtual body (13, 14) and the at least one virtual object (3, 4) by another link between the virtual body (13, 14) and another of the virtual objects (3, 4).

17. The method as claimed in claim 15, further comprising subjecting the 3D model (39), when the link (24) is replaced by said another link (24), to an isometric transformation, until the virtual body (13, 14) and the other of the virtual objects (3, 4) are in line at least within a tolerance range.

18. The method as claimed in claim 17, further comprising altering an attitude of the real model (7, 8), until the associated virtual body (13, 14) is in line with the at least one virtual object (3, 4) or with the other of the virtual objects (3, 4), and then activating a link (24) between the virtual body (13, 14) and the virtual object (3, 4) or the other virtual object (3, 4).

19. The method as claimed in claim 18, wherein multiple ones of the virtual bodies (13, 14) are linked to respective ones of the virtual objects (3, 4) of the 3D model (39), and the method includes altering the individual links (24) independently of one another.

20. The method as claimed in claim 19, further comprising outputting an update of coordinates of the at least one virtual object (3, 4) for editing design data relating to the 3D model (39).

21. The method as claimed in claim 20, wherein the installation is for the pharmaceutical sector for processing carried out in a protected space.

22. The method for testing the function of an installation in claim 21, wherein the installation is represented as the virtual 3D model (2) comprising the virtual objects (3, 4), wherein the real model (7, 8) is provided for at least one of the virtual objects (3, 4) and wherein the virtual body (13, 14) is aligned with the real model (7, 8) at recurring times using the 3D position measurement and the at least one object is linked to the virtual body (13, 14) and put into the desired positional relationship with the virtual body (13, 14), the method further comprising producing a real model (7,8) that corresponds to the at least one virtual object (3, 4) and that is provided with identifiable features for a 3D position measurement, and storing a correspondence (15) between the identified features and the at least one virtual object (3, 4) being stored.

23. The method as claimed in claim 22, wherein the identifiable features are configured at predetermined positions in the real model (7,8).

24. The method as claimed in claim 23, further comprising measuring at least one position of configured features on the real model (7, 8).

25. The method as claimed in claim 24, wherein an operator wears a glove and/or a hand tracking device (27), and/or wherein a 3D position of one or more fingers and/or a hand and/or an arm is recurrently determined.

26. The method as claimed in claim 25, wherein the 3D model (39) represents a shoulder ring, to whose position a real shoulder ring (33, 34) is set, and/or wherein an operator puts an arm through the shoulder ring (33, 34).

27. The method as claimed in claim 26, further comprising defining a capture pose of an onlooker relative to the shoulder ring (33, 34).

28. The method as claimed in claim 27, wherein the at least one virtual object (3, 4) is or has a door (47) of a transfer port (48).

29. The method as claimed in claim 28, further comprising providing a further real model (44) in the 3D model (39) for a further virtual object (3, 4), the real model (7, 8) being arranged so as to move relative to the further real model (44).

30. The method as claimed in claim 29, wherein at least part of the further real model (44) does not move and/or at least part of the further real model (44) moves in relation to a demarcation of the installation.

31. The method as claimed in claim 30, further comprising the following steps: providing CAD data relating to the installation, creating the at least one real model (7, 8) for at least some of the CAD data, installing the at least one real model (7, 8) in a 3D measuring device (11), displaying a virtual 3D model (2), created from the CAD data, by processing at least 3D measurement data of the 3D measuring device (11).

32. The method as claimed in claim 31, further comprising determining a field of view (19) of a head-mounted display (16) using the 3D measuring device (11).

33. The method as claimed in claim 32, further comprising displaying the 3D model (39) with respect to the field of view (19) of the head-mounted display (16).

34. The method as claimed in claim 33, further comprising automatically reconstructing a change on the at least one real model (7, 8) on the 3D model (39).

35. The method as claimed in claim 34, further comprising transporting the 3D measuring device (11) in a fixed test rig prior to being installed.

36. The method as claimed in claim 35, further comprising adjusting the real model (7, 8) in motorized fashion and/or adjusting the real model (7, 8) until a detected variance (64) in a position and/or attitude of the virtual body (13, 14) from the corresponding virtual object (3, 4) is within a tolerance range.

37. The method as claimed in claim 36, further comprising generating a virtual light beam (55) and determining whether the virtual light beam (55) is interrupted.
